(19) United States
(12) Patent Application Publication
(10) Pub. No.: US 2014/0194294 A1
(43) Pub. Date: Jul. 10, 2014

(54) METHOD FOR PRODUCING SUPERCONDUCTING COILS AND APPARATUS HAVING A SUPERCONDUCTING COIL PRODUCED IN ACCORDANCE WITH THE METHOD

(71) Applicant: Dierk Schröder, Selent (DE)

(72) Inventor: Dierk Schröder, Selent (DE)

(73) Assignee: Siemens Aktiengesellschaft, Munchen (DE)

(21) Appl. No.: 14/240,228

(22) PCT Filed: Aug. 6, 2012
(86) PCT No.: PCT/EP2012/065362

§ 371 Date: Feb. 21, 2014

(30) Foreign Application Priority Data
Aug. 24, 2011 (DE) 10 2011 081 465.5

(51) Int. Cl. H01F 41/04; H01F 6/06

(52) U.S. Cl. CPC H01F 41/048; H01F 6/06
USPC 505/211; 505/434; 336/222; 427/63

(57) ABSTRACT

The present invention relates to a method for producing superconducting coils (1) having the steps of providing a substrate (2) and applying a superconducting material in the form of at least one coil onto the substrate. The application of the superconducting material is performed by at least one coating method directly on the substrate. Winding coated flat wires can be dispensed with. Furthermore, the present invention comprises a superconducting apparatus comprising a superconducting coil (1) produced in accordance with the method.

The present invention relates to a method for producing superconducting coils having the steps of providing a substrate and applying a superconducting material in the form of at least one coil onto the substrate. The present invention also comprises a superconducting apparatus having a superconducting coil produced in accordance with the method.

One of the major obstacles during the production of superconducting, in particular high-temperature superconducting (HTS) apparatuses such as, for example, HTS machines, is the poor availability of conductive material in strip or wire form with the required specifications. The maximum producible lengths of high-quality HTS strips lie within the 2000 m range. The strips are usually made of a strip-shaped base material such as, for example, steel strip, and a superconducting coating. When wound on a substrate, these strips form coils, which are part of the superconducting apparatus. Thus, the coils, can, for example, be a part of rotor in an electric motor or generator.

The superconducting coating on the strip-shaped base material produces a strip with no or greatly reduced flexibility. The superconducting material is usually ceramic and may flake off from the strip-shaped base material on bending or the superconducting layer may become brittle. During the winding of the strips to form coils on a substrate, which can, for example, have a rod-shaped, hollow-cylindrical or square shape, the strips may be exposed to strong tensile, bending and/or torsional forces. These result in a deterioration of the superconducting properties of the strips right up to the complete destruction of the superconducting layer on the strips.

It is therefore the object of the present invention to disclose a method for producing superconducting coils and superconducting apparatuses with which deterioration or destruction of the superconducting properties of superconductors during the production of superconducting coils is prevented. It is in particular an object of the present invention to prevent bending of a layer of superconducting material due to the winding of superconducting strips during the method for producing superconducting coils and to disclose apparatuses which comprise superconductors with good superconducting properties.

The stated object is achieved with respect to the method for producing superconducting coils with the features of claim 1 and with respect to the apparatuses with the features of claim 10.

Advantageous embodiments of the method according to the invention for producing superconducting coils and the superconducting apparatus according to the invention may be derived from the respective dependent subclaims. At the same time, the features of the main claim can be combined with features of the subclaims and features of the subclaims can be combined with one another.

The method according to the invention for producing superconducting coils comprises the steps of providing a substrate and applying a superconducting material in the form of at least one coil onto the substrate. The application of the superconducting material is performed by at least one coating method directly on the substrate. This enables winding of coated flat wires to be dispensed with.

Direct application, with or without interlayers, such as, for example, adhesive layers or layers for epitaxial growth, enables the bending of layers of superconducting material to be prevented during the winding of superconducting strips. With direct application, conductors forming a coil directly on the substrate can be formed by the coating method or the conductors can be formed in the shape of a coil in further method steps such as, for example, lithography methods and/or etching. This prevents deformation and destruction during the formation of the coil of the superconducting material, which is usually ceramic and hence fragile and brittle on deformation. Substrate should be understood to mean a solid material on which conductive strips from the prior art are wound in order to form a coil. For example, a substrate can have a rod-shaped, hollow-cylindrical or square shape and can be part of a rotor of a motor or generator. The winding carrier can, for example, be the rotor itself or parts thereof, which results in good magnetic field distribution during operation.

The coating method can comprise a galvanic method and/or a spraying method and/or a sputtering method and/or a vapor deposition method. This can be performed in a liquid, in air, under an inter-gas atmosphere or under vacuum depending upon the method used. For example galvanic methods are performed in liquids, spraying methods in air or under vacuum and sputtering methods and vapor deposition methods under vacuum or under ultrahigh vacuum conditions. It is also possible to use other coating methods with which a solid material is formed on the substrate. The coating method is the opposite of a method such as, for example, winding a strip on a substrate.

The coating method enables the direct formation of at least one superconducting conductor, in particular a high-temperature superconducting conductor, which forms at least one coil. This can be performed, for example, by spraying superconducting material in solid state and at cryogenic temperatures directly in conductor shape. This enables additional steps such as, for example, masking and/or etching to be dispensed with. When forming a coil with more than one winding level arranged superposed on each other, further steps can be used for the electrical insulation of different layers from each other. For example, insulators can be formed as a layer over a layer of conductors, in particular by deposition or winding and electric contact points can be established between different conductor layers by etching, drilling, in particular laser drilling, and/or milling.

The superconducting material used can be a ceramic material, in particular SnTi and/or NbTi and/or MgB₂ and/or BiSrCaCuO and/or YBaCuO. It is also possible to use other superconducting materials and/or mixtures which can be applied on a substrate by a coating method. In this context, superconducting materials should be understood to mean materials which, in the finally processed state, become or are superconductive below a critical temperature T_{K}. High-temperature superconductors can, for example, be superconductive at the temperature of liquid nitrogen.

An insulator can be applied, in particular with the same coating method, with which the superconducting ceramic material is and/or was applied. The insulator can electrically insulate the superconducting conductor of the coil from the environment or prevent direct electrical contact of conductors of different coil levels of a coil with the exception of the contact points for connecting the levels.

The insulator applied can be an oxidic material, in particular a metallic oxide, or plastic. For example, as the insulator, it is possible to apply an insulating varnish or to wind a film over conductors or material of the conductor can be oxidized on the surface resulting in an electrically insulating surface.

The substrate can comprise on its surface adhesive and/or insulating and/or coating layers, which in particular effect epitaxial growth of the superconducting ceramic material with good adhesion directly on the substrate. For example, conductors can be formed with preferred crystalline and/or electrical orientations and/or good mechanical adhesion of the conductors on the substrate can be effected.

The substrate can be provided in the form of a hollow cylinder and/or the substrate can be provided in a shape for the creation of a race-track. For example, different coils can be created on the substrate, for example race-track-shaped, depending upon the desired application. The substrate can be a rotor of a machine or be or become fastened to a rotor as a winding carrier.

The substrate can comprise a material formed from plastic, metal, in particular copper or steel, or from metal oxide.

A superconducting apparatus according to the invention comprises a superconducting coil produced with a method as described above, in particular a high-temperature superconducting coil. The use of the coils produced with the method as described above enables apparatuses to have good properties, such as, for example, a high degree of efficiency. The conductors of the coils have better superconducting properties because damage to the superconducting layers during production, for example due to mechanical stresses and/or bending, is avoided. It is possible to create coils with very long conductors compared to conventional methods in which the superconducting material is applied on a conductive strip. Application on a large coil body is easier to perform than application on thin conductor strips.

The apparatus according to the invention can be an electric motor and/or a current limiter and/or a magnetic resonance tomograph and/or a fusion reactor. In these applications, superconducting coils with good superconducting properties are required or used. The method described above can result in improved properties, for example a higher degree of efficiency, better switching properties, a better signal/noise ratio, higher power, an improved degree of efficiency of the apparatus, depending upon the above-described application.

The advantages associated with the apparatus according to the invention with a superconducting coil are similar to the advantages which were described above with respect to the method according to the invention for the production of superconducting coils.

Preferred embodiments of the invention with advantageous developments according to the features of the dependent claims are described below in more detail with reference to the sole FIGURE but without being restricted thereto.

The FIGURE shows:

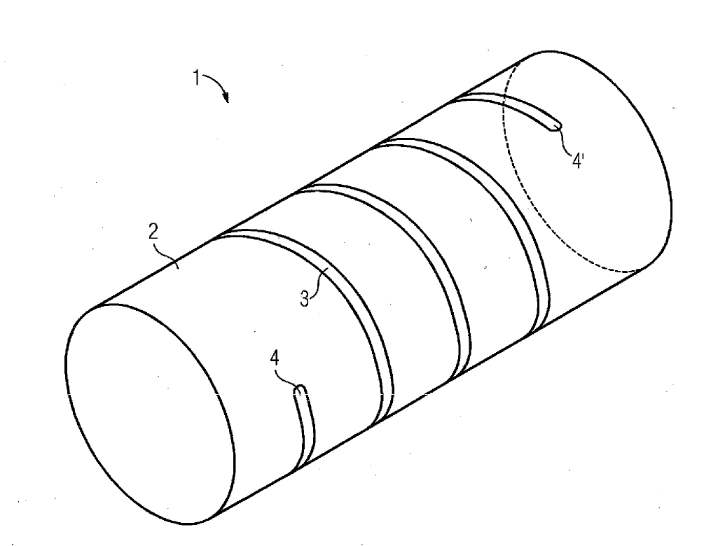

FIG. 1 a schematic sectional view of a superconducting coil 1 produced with the method according to the method.

FIG. 1 shows a superconducting coil 1 formed from a conductor 3 on a substrate 2. Electrical contact points 4 for electrical contacting of the coil 1 are provided at both the start and the end of the conductor 3.

For purposes of simplicity, FIG. 1 only shows one level of a coil. A coil 1 can also be formed by producing a plurality of superposed levels, in each case with an electrical insulator between the levels. The conductors 3 of two adjacent levels can each be electrically connected to each other at a contact point 4. The contact points 4 can be released from an insulator by etching or drilling for example.

The above-described method can be used to produce not only individual coils but also coil systems. It is also possible for different types of carriers 2 to be used in different apparatuses. For example, substrates in a flat shape instead of an elongated hollow-cylindrical shape carrying coils in race-track form can be used in rotors of superconducting machines.

For current limiters, for example, coil shapes are also possible which are formed with opposite “winding directions” at different levels. This can, inter alia, reduce electrical losses and result in improved properties of the superconducting devices.

A combination of the above-described apparatuses and methods and combination with apparatuses and methods known from the prior art is also possible.

The essence of the present invention is the fact that the application of the superconducting layer of superconducting coil directly on a substrate, i.e. a winding carrier, prevents damage to or destruction of the layer due to steps of the method such as bending or drawing. Here, directly on the substrate should be understood as meaning that there is a chemical or physical bonding of the layer to the substrate. In contrast to this, in the prior art a superconducting layer is bonded chemically or physically to a conductive strip and this conductive strip is wound on a substrate. In this case, the conductive strip lies loosely on the substrate and can only be bonded to the substrate in further steps, for example by casting a resin. When the strip is wound with the superconducting, for example ceramic, coating the superconducting layer can be damaged resulting in a deterioration of the superconducting properties. This is prevented with the present invention.

1.-11. (canceled)

12. A method for producing a superconducting coil, comprising the step of directly coating a superconducting material in the form of at least one coil onto a substrate.

13. The method of claim 12, wherein the coating step includes a process selected from the group consisting of galvanizing, spraying, sputtering, and vapor deposition.

14. The method of claim 12, wherein the coating step is executed in a liquid, in air, under an inter-gas atmosphere or under vacuum.

15. The method of claim 12, wherein the coating step directly forms at least one superconducting conductor.

16. The method of claim 12, wherein the coating step directly forms a high-temperature superconducting conductor, which also forms the at least one coil.

17. The method of claim 12, wherein the superconducting material is a ceramic material.

18. The method of claim 17, wherein the ceramic material is a member selected from the group consisting of SnTi, NbTi, MgB₂, BiSrCaCuO, YBaCuO, and any combination thereof.

19. The method of claim 12, further comprising the step of applying an insulator onto the superconducting material.

20. The method of claim 19, wherein the applying step is executed by a same process as the coating step is executed.

21. The method of claim 19, wherein the insulator is made of a material selected from the group consisting of oxidic material and plastic.

22. The method of claim 21, wherein the oxidic material is metallic oxide.

23. The method of claim 12, further comprising applying on a surface of the substrate a material selected from the group consisting of adhesive, insulating layer and coating layer.

24. The method of claim 17, further comprising applying on a surface of the substrate a material selected from the group consisting of adhesive, insulating layer and coating layer to effect epitaxial growth of the superconducting material of ceramic material and enhance adhesion of the superconducting material of ceramic material directly on the substrate.

25. The method of claim 12, wherein the substrate is configured in the form of a hollow cylinder or shaped to create a race-track.

26. The method of claim 12, wherein the substrate comprises a material selected from the group consisting of metal and metal oxide.

27. The method of claim 26, wherein the metal is copper or steel.

28. A superconducting apparatus, comprising a superconducting coil produced by directly coating a superconducting material in the form a coil onto a substrate.

29. The superconducting apparatus of claim 28, wherein the superconducting coil is a high-temperature superconducting coil.

30. The superconducting apparatus of claim 28, constructed in the form of an electric motor, a current limiter, a magnetic resonance tomograph, or a fusion reactor.
